(19) United States
(12) Patent Application Publication
(10) Pub. No.: US 2005/0266764 A1
(43) Pub. Date: Dec. 1, 2005

(54) Method of stabilizing field emitter

(76) Inventors: Won-Seok Kim, Yongin-si (KR); Gi-Young Kim, Yongin-si (KR); Sang-Hyun Lee, Yongin-si (KR); Jung-Na Heo, Yongin-si (KR); Hyun-Jung Lee, Yongin-si (KR)

Correspondence Address: Robert E. Bushnell, Suite 300, 1522 K Street, N.W., Washington, DC, 20005, US

(21) Appl. No.: 11/139,664

(22) Filed: May 31, 2005

(30) Foreign Application Priority Data
May 29, 2004 (KR) 10-2004-0038744

(51) Int. Cl. H01J 9/00

(52) U.S. Cl. 445/24

(57) ABSTRACT

A method of stabilizing a field emitter includes performing plasma treatment on carbon nanotubes of the field emitter. The plasma treatment evens the surface of the carbon nanotubes, stabilizing the current density of the carbon nanotubes and increasing the durability of the field emitter.

### CLAIM OF PRIORITY

This application makes reference to, incorporates the same herein, and claims all benefits accruing under 35 U.S.C. § 119 from an application for METHOD FOR STABILIZATION OF FIELD EMITTERS earlier filed in the Korean Intellectual Property Office on 29 May 2004 and there duly assigned Serial No. 10-2004-0038744.

### BACKGROUND OF THE INVENTION

1. Field of the Invention

The present invention relates to a method of stabilizing the current of a field emitter, and more particularly, to a method of stabilizing the current of a field emitter, in which nanotubes of the carbon nanotube field emitter are treated with plasma to stabilize current density and improve durability.

2. Description of the Related Art

Carbon nanotubes are an allotrope of carbon and are formed in a hexagonal-tube shape, with a large aspect ratio but very small nanometer scale diameter. Since carbon nanotubes are chemically stable and metallic or semi-conducting, they are a promising new material for various applications, such as a field emission source, a hydrogen storage medium, and a polymer intensifier.

Carbon nanotubes can be fabricated by physical methods or chemical methods. Physical methods include arc charging, laser evaporation, and so on. Chemical methods include chemical vapor deposition (CVD), such as thermal chemical vapor deposition and plasma enhanced chemical vapor deposition.

When carbon nanotubes are formed as an electron emission source of a display, they are directly grown on a substrate, or a carbon containing paste is printed on the substrate. An electric potential is applied to electrodes to form an electric field, which makes the nanotubes emit electrons from their tips to drive the display.

FIG. 1 is a sectional view of carbon nanotubes formed on a substrate.

Referring to FIG. 1, a lower electrode 11 is formed on a substrate 10 and then carbon nanotubes 12 are formed on the lower electrode 11. In the drawing, the carbon nanotubes 12 are exaggerated for clarity. When the carbon nanotubes 12 are directly grown on the substrate 10 or printed on the substrate 10, it is difficult to form the carbon nanotubes 12 with uniform length, conductivity, or growth configuration. The uneven carbon nanotubes 12a make the entire field emitter abnormal and emit an uneven electric field.

When carbon nanotubes are used as the field emission source of the field emitter, a drastic drop of electric field density is easily observed at an early stage of operation. It is known that this drop occurs because the abnormal carbon nanotubes 12a among the carbon nanotubes 12 formed on the substrate operate abnormally under the electrical potential applied to the electrodes. The abnormal operation causes low field emission rate, short lifespan and uneven field emission of the field emitter.

### SUMMARY OF THE INVENTION

It is therefore, an object of the present invention to provide, a method of stabilizing a field emitter, in which a plasma treatment is performed on the field emitter to prevent abnormal field emission and improve performance.

It is another object of the present invention to provide a technique with when the carbon nanotubes are used as a field emission source of the field emitter, the surface of the carbon nanotubes can be evenly formed by the plasma treatment, thus making it possible to attain stable field emission and extend the lifespan of the field emitter.

It is yet another object of the present invention to provide a technique of stabilizing a field emitter that is easy to implement and efficient.

According to an aspect of the present invention, there is provided a method of stabilizing a field emitter that uses carbon nanotubes as a field emission source. The method includes performing a plasma treatment on the carbon nanotubes.

Performing the plasma treatment includes: mounting the field emitter having the carbon nanotubes within a chamber; removing gas from the chamber and filling the chamber with a plasma forming gas; and applying a voltage to the chamber to generate plasma and performing the plasma treatment on the field emitter.

The field emitter includes a lower electrode on which the carbon nanotubes are formed, and an upper electrode installed in an upper portion of the chamber, opposing the carbon nanotubes.

The plasma forming gas includes at least one of inert gas, N₂, O₂, and H₂.

Filling the chamber with the plasma forming gas includes maintaining the vacuum of the chamber to at least 10⁻³ Torr.

The voltage applied to the chamber is at least 10 V (volts).

The plasma treatment is performed for at least ten seconds.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a sectional view of carbon nanotubes formed on a substrate according to the related art;

FIG. 2 is a schematic view of a chamber in which plasma treatment is performed to stabilize a field emitter according to the present invention;

FIGS. 3A and 3B are views showing the principle of plasma treatment performed to stabilize a field emitter according to the present invention;

FIGS. 4A and 4B are SEM images showing the surface of a carbon nanotube field emitter, respectively taken before and after plasma treatment according to the present invention; and

FIG. 5 is a graph showing current density curves of a carbon nanotube field emitter with respect to time, respectively plotted before and after plasma treatment according to the present invention.

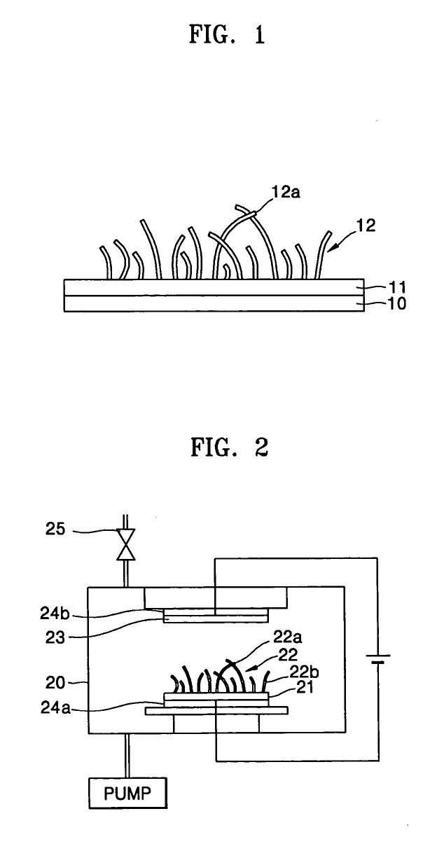

### DETAILED DESCRIPTION OF THE INVENTION

The present invention will now be described more fully with reference to the accompanying drawings.

FIG. 2 is a schematic view of a chamber in which plasma treatment is performed to stabilize a field emitter according to one embodiment of the present invention.

Referring to FIG. 2, carbon nanotubes 22 are formed on a cathode 21 and the cathode 21 is placed in a chamber 20. The carbon nanotubes 22 can be grown by a selective use of carbon nanotube growth methods, such as direct growth printing with carbon nanotube paste. Since carbon nanotube growth methods are well known, their detailed description will be omitted.

An anode 23 is located in the chamber 20, spaced away from the carbon nanotubes 22 by a predetermined distance. The cathode 21 and the anode 23 can be made of any suitable conductive material, such as metal electrode or oxide electrode. That is, the materials for the cathode 21 and the anode 23 are not limited. Plasma is formed by supplying power to the cathode 21 and the anode 23. The cathode 21 and the anode 23 can be respectively formed on substrates 24a and 24b and installed within the chamber 20.

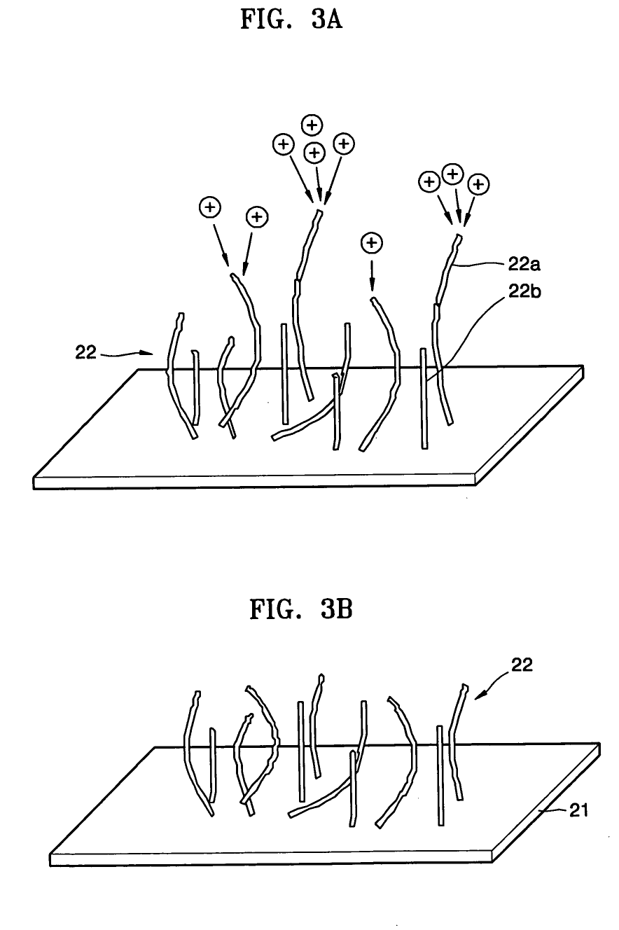

A plasma treatment process of stabilizing the field emitter will now be fully described with reference to FIGS. 2 and 3.

Referring again to FIG. 2, a conventional vacuum system such as a pump is used to create a vacuum inside the chamber 20. For example, a rotary pump removes gas from the chamber 20 until the chamber reaches a high vacuum of 10⁻² to 10⁻³ Torr, and then, a turbo pump achieves an ultra high vacuum of 10⁻⁸ Torr.

Most of the gas in the chamber 20 is removed by the vacuum system and this pressure of the chamber 20 is defined as an initial vacuum. Of course, the initial vacuum of the chamber 20 may be selectively adjusted, and more particularly, may be adjusted to maintain a vacuum higher than about 10⁻³ Torr when a plasma forming gas is introduced.

A valve 25 connected to the chamber 20 is used to introduce the plasma forming gas into the chamber 20. The plasma forming gas is not limited. For example, N₂, H₂, O₂, or inert gases such as Ar and Ne, can be used individually or together for the plasma forming gas. When the chamber 20 is filled with the plasma forming gas, the chamber 20 must be properly maintained at pressure higher than about 10⁻³ Torr to stably maintain the plasma.

After the plasma forming gas is introduced into the chamber 20, a voltage is applied to the cathode 21 and the anode 23. The voltage can be set to an ordinary level as is used in a conventional plasma process, and is at least 10 V. When this electrical energy is applied, the plasma forming gas in the chamber 20 is activated into plasma, divided into negative electrons and positive ions. The positive ions or radicals of the plasma collide with the tips of the carbon nanotubes 22 formed on the lower cathode 21, changing the physical and chemical properties of the carbon nanotubes 22. For example, roughness of the carbon nanotubes 22 may be removed.

FIGS. 3A and 3B are schematic views showing the collision of the positive ions with the tips of the carbon nanotubes.

Referring to FIG. 3A, since it is difficult to evenly grow the carbon nanotubes 22 on the cathode 21, the surface of the carbon nanotubes 22 is rough. In detail, the carbon nanotubes 22 have different heights. That is, long carbon nanotubes 22a and short carbon nanotubes 22b are formed.

As described above in the description of the related art, the uneven carbon nanotubes cause the field emitter to emit an unstable field. The positive ions of the plasma are concentrated on the tips of the long carbon nanotubes 22a, reducing their length. The plasma treatment process is performed for several tens of seconds or several minutes. After the plasma treatment process, the carbon nanotubes 22 have uniform heights, as shown in FIG. 3B.

To check the effectiveness of the plasma treatment at stabilizing the field emitter according to the present invention, changes in the shape and electrical properties of the carbon nanotubes 22 were observed before and after the plasma treatment.

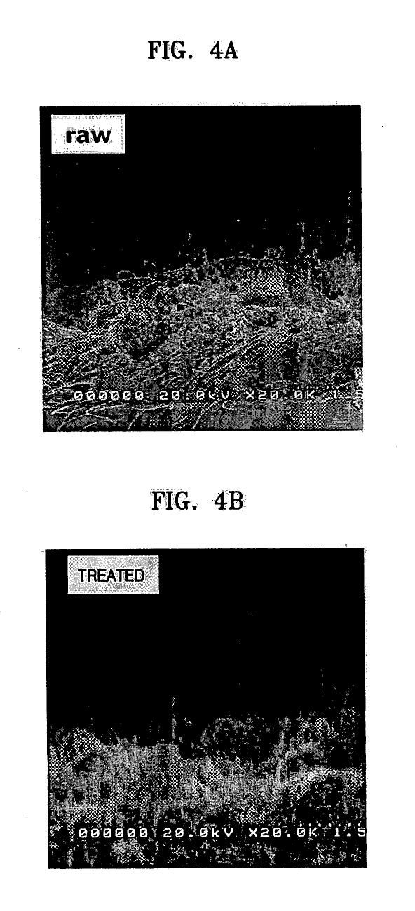

FIGS. 4A and 4B are SEM images showing specimens of the carbon nanotube field emitter, respectively taken before and after a plasma treatment according to the present invention. The substrate 24a was a glass substrate; the cathode 21 and the anode 23 were formed of indium tin oxide (ITO); the carbon nanotubes 22 were formed on the cathode 21 by printing a carbon containing paste; and the two SEM images were taken at the same magnification.

Referring to FIG. 4A, the surface of the carbon nanotubes 22 before the plasma treatment was very rough and formed unevenly into large lumps. The surface image of FIG. 4A is similar to a normal image of a field emitter that has carbon nanotubes 22 grown by a conventional method.

Referring to FIG. 4B, Ne gas was used to form the plasma; the vacuum was maintained at about 10 Torr; plasma was formed by applying about 250 V between the cathode 21 and the anode 23; and the plasma treatment was performed for several minutes. Then, the surface of the carbon nanotubes 22 was inspected after the plasma treatment. When the SEM image of FIG. 4B is compared to that of FIG. 4A, the surface roughness is less, and relatively small lumps are evenly distributed without the large lumps shown in FIG. 4A.

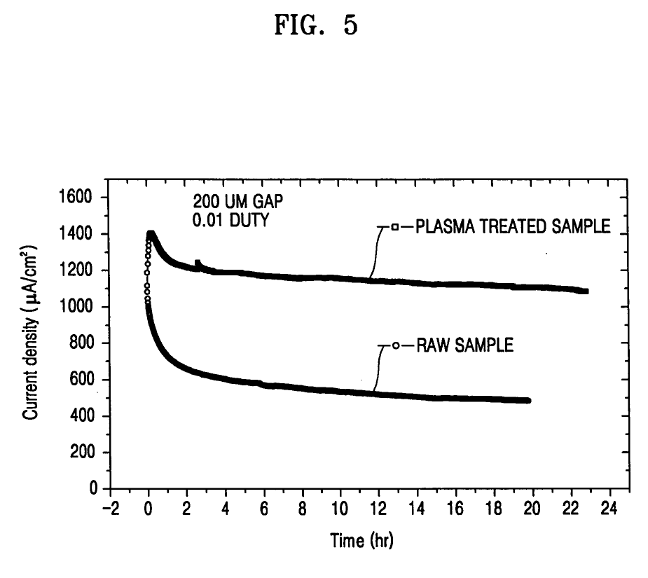

FIG. 5 is a graph showing current density curves of the carbon nanotube specimen shown in FIGS. 4A and 4B with respect to time, respectively plotted before and after the plasma treatment. The X-axis of the graph denotes time (hours) during which an external voltage is applied to the field emitter. The external voltage can be applied in various ranges. In the actual experiment, about 4-7 V/μm (volts per microns) was applied to the field emitter. The Y-axis of the graph denotes the current density, which is current per square centimeter [μA/cm²], of the carbon nanotubes 22 of the field emitter.

Referring to FIG. 5, the two current density curves of the carbon nanotubes 22, plotted before and after the plasma treatment, are almost identical at the start but immediately diverge. In detail, before the plasma treatment, the current density of the carbon nanotubes 22 starts at about 1400 μA/cm² but falls quickly to below 600 μA/cm². After the plasma treatment, however, the current density of the carbon nanotubes 22 starts at about 1400 μA/cm² and falls only slightly, by staying above 1100 μA/cm². Therefore, the current density of the carbon nanotubes 22 can be stabilized by the plasma treatment, giving the carbon nanotubes 22 improved durability.

That is, the plasma treatment makes it possible to give the carbon nanotubes 22 an even surface, allowing the field emitter stable field emission and greatly increased durability.

As described above, according to the present invention, when the carbon nanotubes 22 are used as a field emission source of the field emitter, the surface of the carbon nanotubes 22 can be evenly formed by the plasma treatment. Thus, it is possible to attain stable field emission and extend the lifespan of the field emitter.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of stabilizing a field emitter that uses carbon nanotubes as a field emission source, the method comprising performing plasma treatment on the carbon nanotubes accommodating a reduction in surface roughness of said carbon nanotubes after performing said plasma treatment.

2. The method of claim 1, wherein performing said plasma treatment comprises:
mounting said field emitter including said carbon nanotubes in a chamber;
removing gas from said chamber and filling said chamber with a plasma forming gas; and
applying a voltage to said chamber to generate plasma and performing said plasma treatment on said field emitter.

3. The method of claim 2, wherein said field emitter comprises a lower electrode on which said carbon nanotubes are formed.

4. The method of claim 2, wherein an upper electrode is installed in an upper portion of said chamber and faces said carbon nanotubes.

5. The method of claim 2, wherein the plasma forming gas comprises at least one of inert gas, N₂, O₂, and H₂.

6. The method of claim 2, wherein filling the chamber with the plasma forming gas comprises maintaining the vacuum of the chamber to at least 10⁻³ Torr.

7. The method of claim 2, wherein the voltage applied to the chamber is at least 10 volts.

8. The method of claim 2, wherein said plasma treatment is performed for at least ten seconds.

9. The method of claim 2, with a distribution of said carbon nanotubes being more even with smaller lumps after said plasma treatment.

10. The method of claim 2, with filling the chamber with the plasma forming gas comprises maintaining the vacuum of the chamber to about 10⁻³ Torr.

11. The method of claim 2, with the current density of said carbon nanotubes being at least 1100 μA/cm².

12. The method of claim 2, with said carbon nanotubes comprising long and short carbon nanotubes, and after plasma treatment, modifying the long and short carbon nanotubes to have less difference in lengths to accommodate the reduction in surface roughness.

13. A method of stabilizing a field emitter that uses carbon nanotubes as a field emission source, the method comprising performing plasma treatment on the carbon nanotubes,
said plasma treatment comprises:
mounting said field emitter including said carbon nanotubes in a chamber;
removing gas from said chamber and filling said chamber with a plasma forming gas; and
applying a voltage to said chamber to generate plasma and performing said plasma treatment on said field emitter.

14. The method of claim 13, wherein said field emitter comprises a lower electrode on which said carbon nanotubes are formed and an upper electrode is installed in an upper portion of said chamber and faces said carbon nanotubes.

15. The method of claim 13, wherein filling the chamber with the plasma forming gas comprises maintaining the vacuum of the chamber to at least 10⁻³ Torr.

16. The method of claim 13, with the voltage applied to the chamber being at least 10 volts, said plasma treatment being performed for at least 10 seconds, and stabilizing a higher current density of said carbon nanotubes after said plasma treatment.

17. A method, comprising:
mounting a field emitter including a plurality of carbon nanotubes in a chamber;
removing gas from said chamber and filling said chamber with a plasma forming gas;
applying a voltage to said chamber to generate plasma and performing as plasma treatment on said field emitter; and
reducing a surface roughness between said plurality of carbon nanotubes after performing said plasma treatment on said field emitter.

18. The method of claim 17, wherein filling said chamber with the plasma forming gas comprises maintaining the vacuum of the chamber to at least 10⁻³ Torr.

19. The method of claim 17, wherein the voltage applied to said chamber is at least 10 volts and said plasma treatment is performed for at least 10 seconds.

20. The method of claim 17, with said carbon nanotubes comprising long and short carbon nanotubes, and after plasma treatment, modifying the long and short carbon nanotubes to have less difference in lengths to accommodate the reduction in surface roughness of the carbon nanotubes, and stabilizing a higher current density of said carbon nanotubes after said plasma treatment.
